(19) United States
(12) Patent Application Publication
(10) Pub. No.: US 2023/0266754 A1
(43) Pub. Date: Aug. 24, 2023

(54) WORK AREA OVERLAY ON OPERATOR DISPLAY

(71) Applicant: Caterpillar Paving Products Inc., Brooklyn Park, MN (US)

(72) Inventors: Nathaniel S. Doy, Maple Grove, MN (US); Joel Case Miller, Washington, IL (US)

(73) Assignee: Caterpillar Paving Products Inc., Brooklyn Park, MN (US)

(21) Appl. No.: 17/676,458

(22) Filed: Feb. 21, 2022

(51) Int. Cl. G05D 1/00; H04N 7/18; H04N 1/387; G06T 11/00

(52) U.S. Cl. CPC G05D 1/0033; H04N 7/181; H04N 1/3876; G06T 11/00

(57) ABSTRACT

A work machine can include an image capturing device configured to capture an image of at least a portion of an environment adjacent to the work machine. The work machine can also include processing circuitry to receive the image from the image capturing device, generate an overlay that depicts a work area for the work machine, superimpose the overlay over the image to generate an enhanced image of the work area, and provide the enhanced image to a display device.

### TECHNICAL FIELD

This disclosure relates to road construction equipment, and more specifically to a system and method for providing operator information during remote control of road construction equipment.

### BACKGROUND

Work machines can be controlled to implement predetermined work plans in a work area. A display can be provided at an operator station on the work machine or remotely from the work machine to allow operators to view the work area and gain a general sense of the position of the work machine in the work area. Additionally, a camera system can provide information regarding the area around the work machine. However, safety concerns can arise if the operator focuses too much attention on the work being implemented rather than on the area around the work machine. Conversely, machine performance can suffer if the operator focuses too much attention on the area around the work machine and insufficient attention on the work being implemented.

US patent application 2014/0375806 discusses a system that includes an image capturing device configured to capture an image of an environment in relation to the machine.

### SUMMARY OF THE INVENTION

In an example according to the present disclosure, a work machine can include an image capturing device configured to capture an image of at least a portion of an environment adjacent to the work machine; and processing circuitry configured to: receive the image from the image capturing device; generate an overlay that depicts a work area for the work machine; superimpose the overlay over the image to generate an enhanced image of an area to be worked in the work area; and provide the enhanced image to a display device.

In another example according to this disclosure, a method for remote control for a work machine can include capturing an image of at least a portion of an environment adjacent to the work machine; generating an overlay that depicts a work area for the work machine; superimposing the overlay over the image to generate an enhanced image of an area to be worked in the work area; and controlling the work machine to perform work in the work area based on the overlay and a position of the work machine within the work area.

In another example, according to the disclosure, a system can include an image capturing device configured to capture an image of at least a portion of an environment adjacent to a work machine; a location sensor configured to detect location of the work machine; processing circuitry configured to: receive the image from the image capturing device; generate an overlay that depicts a work area for the work machine; and superimpose the overlay over the image to generate an enhanced image of an area to be worked in the work area; and a display connected to the processing circuitry and configured to receive the enhanced image and display the enhanced image.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a side view of an asphalt compactor machine, in accordance with this disclosure.

FIG. 2A shows a remote operator station in accordance with this disclosure.

FIG. 2B is schematic diagram depicting an example remote manual and autonomous machine control system in accordance with this disclosure.

FIG. 3A shows a first view of a display for the compactor machine, in accordance with this disclosure.

FIG. 3B shows a second view of a display for the work machine, in accordance with this disclosure.

FIG. 4 illustrates detail of the overlay in accordance with this disclosure.

FIG. 5 is a flowchart depicting an example method of operating a work machine in accordance with this disclosure.

### DETAILED DESCRIPTION

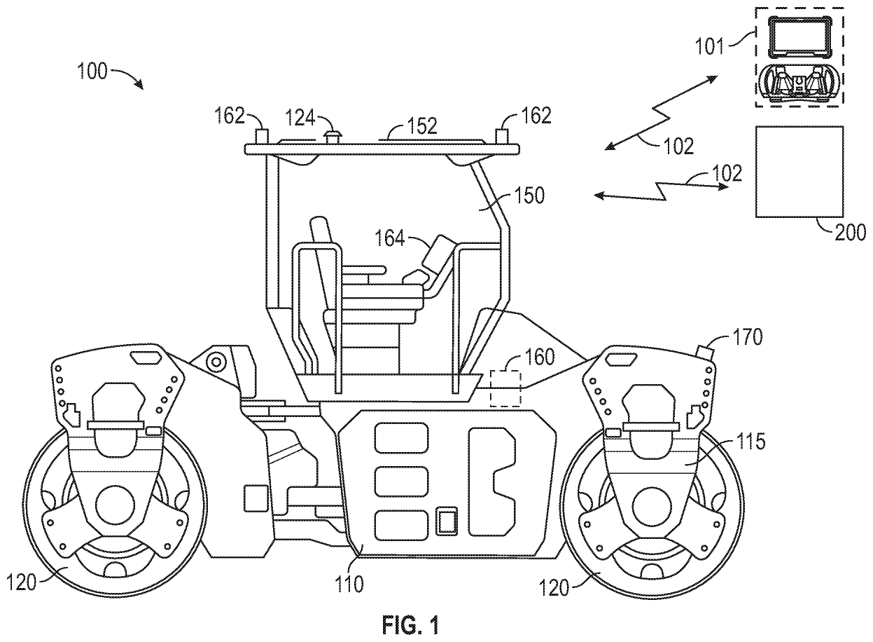

FIG. 1 shows a side view of a compactor work machine 100, in accordance with this disclosure. While example embodiments are described with reference to a compactor work machine 100, examples according to this disclosure are applicable to a variety of types of work machines, including graders, scrapers, dozers, and excavators, as examples.

The work machine 100 generally includes a body or machine frame 110 that connects and associates the various physical and structural features that enable the work machine 100 to function. These features can include an operator's cab 150 that is mounted on top of the machine frame 110 from which an operator may control and direct operation of the work machine 100. Accordingly, a steering feature and similar controls may be located within the operator's cab 150. To propel the work machine 100 over a surface, a power system such as an internal combustion engine can also be mounted to the machine frame 110 and can generate power that is converted to physically move the machine.

Work machine 100 can include at least a cylindrical roller drum 120 which is rotatable about a drum axis oriented generally transverse to a direction of travel of the work machine 100. The roller drums 120 is attached to the machine frame 110 using drum supports 115. The work machine 100 articulates such that the back section can articulate relative to the front section.

The work machine 100 may further include a location sensor 124 connected at one or more locations. The location sensor 124 may be capable of determining a location of the work machine 100 and may include and/or comprise a component of a global positioning system (GPS). For example, the location sensor 124 may comprise a GPS receiver, transmitter, transceiver or other such device, and the location sensor 124 may be in communication with one or more GPS satellites to determine a location of the work machine 100 continuously, substantially continuously, or at various time intervals.

The work machine 100 can include one or more camera's 162 mounted to the machine frame 110 so as to capture an image of at least a portion of an environment adjacent to the work machine 100. For example, camera's 162 can be positioned above a cab roof 152. In some embodiments, a 360° view can be provided although embodiments are not limited thereto, and less than 360° view can be provided. The cameras 162 can provide enough coverage so that a controller 160 can stitch the various views together to create a composite image of the environment adjacent to the work machine 100. However, while the controller 160 can stitch the various views together, the views may also be depicted separately, or only two views may be stitched together, etc. While two cameras 162 are shown, fewer than two cameras may be used, or more than two cameras can be used. A display 164 can be provided in the operator's cab 150 showing the image data provided by the camera's 162.

The work machine 100 can be wirelessly communicatively connected using connection 102 to remote control apparatus 101 and/or to a remote operator station 200 (FIG.

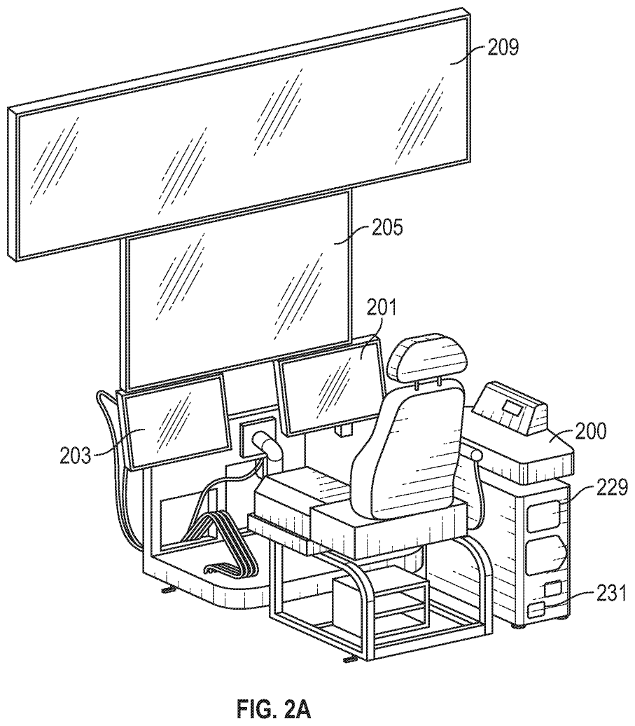

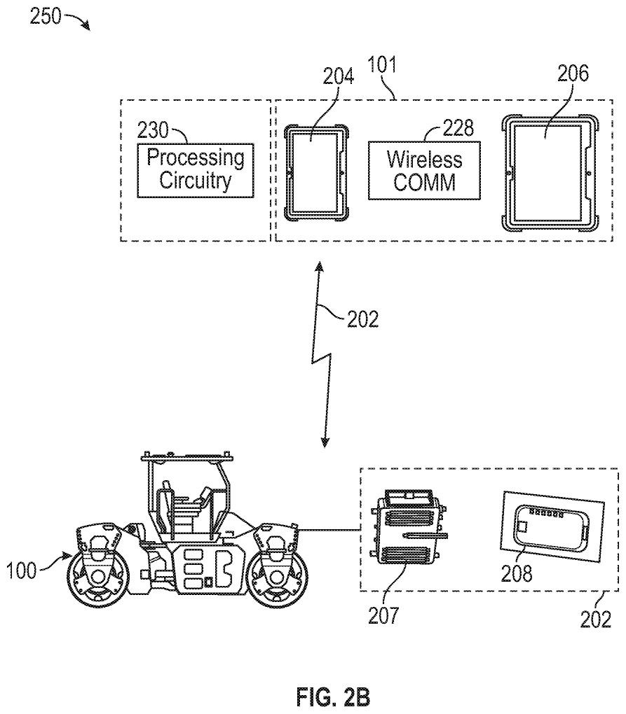

FIG. 2A illustrates a remote operator station 200 in accordance with some aspects. The remote operator station 200 can include a machine display 201 to display various aspects of a work machine 100 including sensor data, dashboard metrics (e.g., engine RPM, engine temperature, oil gauge information, etc.). The information for displaying on machine display 201 can be provided over connection 102 (FIG. 1) using wireless communication circuitry 229 as described later herein.

The remote operator station 200 can further include an autonomous machine display 203 to provide information including grade control information, location information, 3D surface information, etc. received over the connection 102. Camera's 162 (FIG. 1) can provide image data over connection 102 to be viewed on display 205. Display 209 can display information from site cameras around a work site of the work machine 100, including security cameras or other cameras remote from the work machine 100 (not shown in FIG. 1). The remote operator station 200 can include and processing circuitry 231 processing data of the work machine 100, associated camera/s 162, etc. and for providing information for display on displays 201, 203, 205 and 209. The processing circuitry 231 is shown as co-located with the remote operator station 200, but embodiments are not limited thereto and the processing circuitry 231 can be completely or partially located remote from the remote operator station 200, in the cloud, or as a standalone computing system.

In addition to or instead of providing image data to the remote operator station 200, image data provided by the camera/s 162 can be provided over the connection 102 to processing circuitry at the remote control apparatus 101. In some examples, work machine 100, remote control apparatus 101 and remote operator station 200 each include wireless transceivers and/or wireless network adaptors to communicate information, data, commands, signals indicative of instructions or other functions, etc. between the machine and apparatus. The wireless communication between work machine 100, remote control apparatus 101 and remote operator station 200 can include traditional RF communication capabilities at one or more frequencies and can also include higher bandwidth communication via wide or local area communication networks using, for example, WiFi or another standard or proprietary communication standard/protocol.

The remote control apparatus 101 and the remote operator station 200 are configured to allow a machine operator to configure and execute autonomous tasks and also to remotely manually control the machine as if seated in the machine operator cabin. Thus, in addition to traditional in-situ operation by an operator at operator's cab 150, work machine 100 is configured to execute tasks autonomously without requiring operator input (whether at operator's cab 150 or otherwise). The remote control apparatus 101 and the remote operator station 200 can be arranged remotely from but in relatively close proximity to work machine 100, like at a particular job site. Additionally or alternatively, the remote control apparatus 101 or remote operator station 200 can be situated further remotely from work machine 100, such as at a central operations center or other location remote from the job site at which work machine 100 is located.

Work machine 100 may include one or more controllers or other digital electronics configured to control various aspects of machine operation in accordance with a stored program(s) specifying one or more construction or other types of tasks. Work machine 100 can be configured to receive task instructions and to execute the task autonomously by the controller(s) processing the task instructions/program and causing various systems of work machine 100 (e.g., throttle, braking, steering, implement use and articulation, etc.) to execute the task in accordance with the instructions/program. For safety and other reasons, an operator will typically monitor work machine 100 executing such autonomous tasks, but, barring the need to intervene for some unexpected reason (e.g., avoid an object in machine path), work machine 100 is configured to complete the autonomous tasks without requiring additional input from the operator.

Work machine 100 is also configured to be manually controlled by an operator that is not on/in or at the machine. Manual remote control of work machine 100 may provide a number of benefits over and above the typical in-situ manual control of the machine and work machine 100 operating autonomously to execute predetermined tasks. For example, there are many situations where work machine 100, while operating autonomously, may need to be positioned to start a task or transported from one completed autonomous task to a starting position of a new autonomous task. In such situations, completion of one or more tasks may be substantially improved in efficiency, time, etc. by a remote operator being able to manually control work machine 100 in conjunction with or separate from autonomous tasks being executed by the machine without operator control.

FIG. 2B is a schematic diagram depicting an example remote manual and autonomous machine control system 250 in accordance with this disclosure. In FIG. 2B, system 250 includes work machine 100 and remote control apparatus 101. However, similar communications and control can be maintained between the work machine 100 and the remote operator station 200 (FIG. 2A). Additionally, work machine 100 includes wireless communication module 202 and remote control apparatus 101 includes a user interface 204. In available systems, cameras provide separate input to show surroundings of the work machine 100. A wireless communication module 202 of work machine 100 includes wireless transceiver 207 and wireless network adaptor 208.

The user interface 204 of remote control apparatus 101 can include one or more input devices configured to receive input from the operator related to autonomous tasks of work machine 100 and one or more output devices configured to output information related to the autonomous tasks to the operator. In some examples, and in available systems, a separate second user interface 206 is provided to display at least a portion of an environment adjacent to the work machine 100, using images provided by the cameras 162 (FIG. 1) received over connection 102. Wireless communication circuitry 228 can communicate with wireless communication module 202 of the work machine 100 (and similarly the wireless communication circuitry 229 of the remote operator station 200 can communicate with wireless communication module 202, although this is not shown in FIG. 2B).

Processing circuitry 230 can be associated with the remote control apparatus 101 to receive images from the image capturing devices (e.g., cameras 162) and to generate an overlay as described later herein that depicts a work area for the work machine 100. Similarly, processing circuitry 231 of the remote operator station 200 can receive images from the image capturing devices to generate an overlay as described later herein, although this is not shown in FIG. 2B. The processing circuitry 230 is illustrated as co-located with the remote control apparatus 101 in FIG. 2B, but embodiments are not limited thereto and the processing circuitry 230 can be completely or partially located remote from the remote control apparatus 101, in the cloud, or as a standalone computing system (not shown in FIG. 2B).

Using these two displays the operator, whether remotely controlling the work machine 100 or present in the operator's cab 150, can refer to both the user interface 204 and the user interface 206 to view the surroundings around the work machine 100 and the work area. Similarly, if an operator is using remote operator station 200, the operator can refer to multiple of the displays 201, 203, 205 and 209 for information. However, even with access to multiple displays, the operator still cannot determine how the work area is situated within those surroundings. Furthermore, safety issues can arise if the operator focuses too much attention on the work being implemented rather than on the area around the work machine. Conversely, machine performance can suffer if the operator focuses too much attention on the area around the work machine and insufficient attention on the work being implemented.

To address these and other concerns, systems, apparatuses and methods according to some embodiments can provide a transparent or semi-transparent overlay of work area on camera feeds to generate an enhanced image. Systems, apparatuses and methods according to some embodiments can use knowledge of camera feed relationship to the work machine 100 and the work machine 100 relationship to the earth to superimpose the work area in the camera's view of the earth. The superimposing will cause a depiction of the work area to appear “glued” to the surface of the earth in at least a portion of the environment around the work machine 100. This allows operators to simultaneously view information for implementing work and for environmental awareness on one display for enhanced safety and reduced distraction.

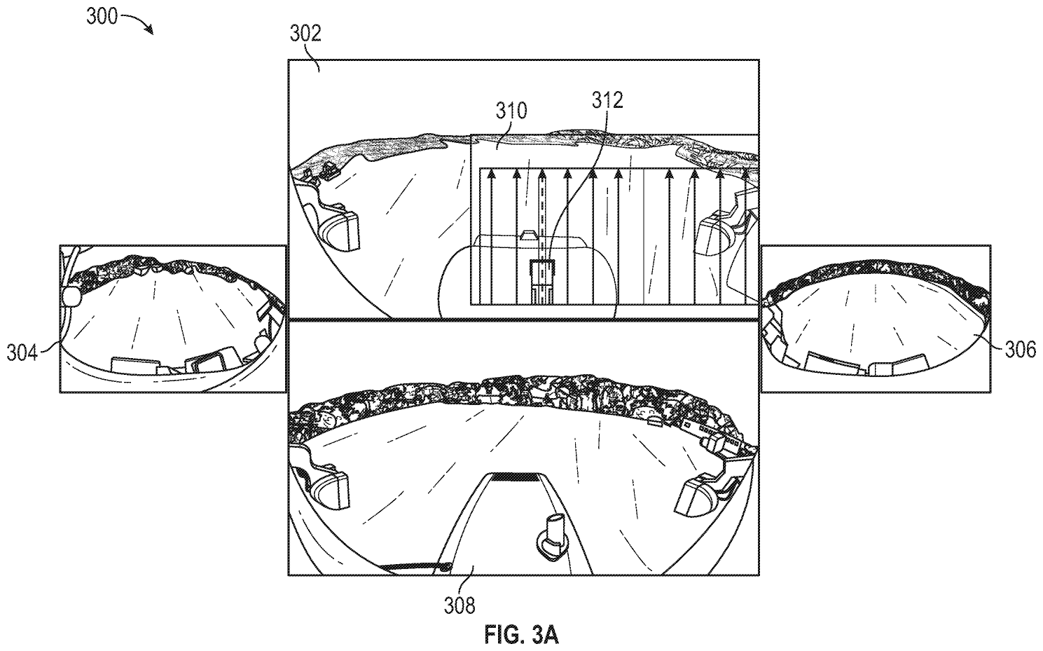

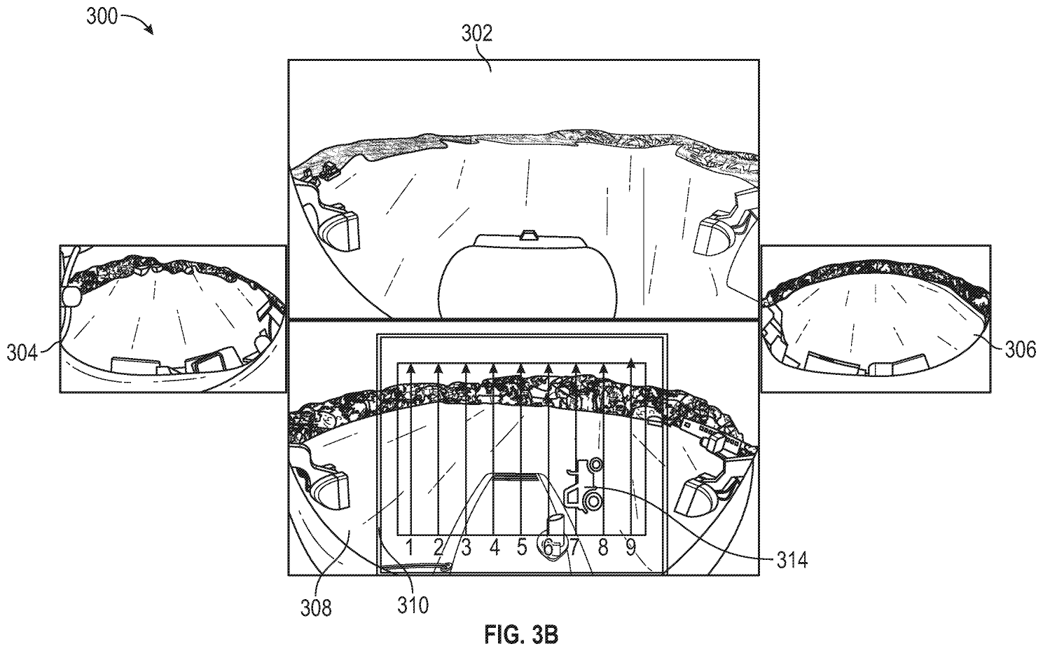

FIG. 3A shows a first view of a display for the work machine, in accordance with this disclosure. FIG. 3A shows an enhanced image 300 including images 302, 304, 306, 308 that have been captured from an image capturing device (e.g., camera/s 162) and stitched together similarly to that shown in FIG. 3A, for example. The different images provided within the enhanced image 300 can represent a front image 302, a first side image 304, a second side image 306, and a rear image 308, relative to the operator's cab 150, of the environment adjacent to the work machine 100. While four images 302, 304, 306, 308 are shown, the enhanced image 300 can provide more than four images and fewer than four images. The images can be provided in a video stream, still format, or any other format.

Processing circuitry 230 (FIG. 2B) or processing circuitry 231 (FIG. 2A) can superimpose an overlay 310 over one or more of the image/s 302, 304, 306, 308 and the provide the enhanced image to a display device. The display device can be local to the work machine 100, and/or remote from the work machine 100 (e.g., at remote operator station 200 or at remote control apparatus 101). The overlay 310 can depict a work area of the work machine 100. In some examples, the overlay 310 is transparent such that no portion of the work machine 100 or images 302, 304, 306, 308 is blocked by the overlay 310. In some examples, the overlay 310 is in a background configuration and any portions of the work machine 100, etc., are kept in a foreground of the enhanced image 300. As described above, the overlay 310 can appear “glued” to the earth, in the example glued to the earth in front of the work machine 100.

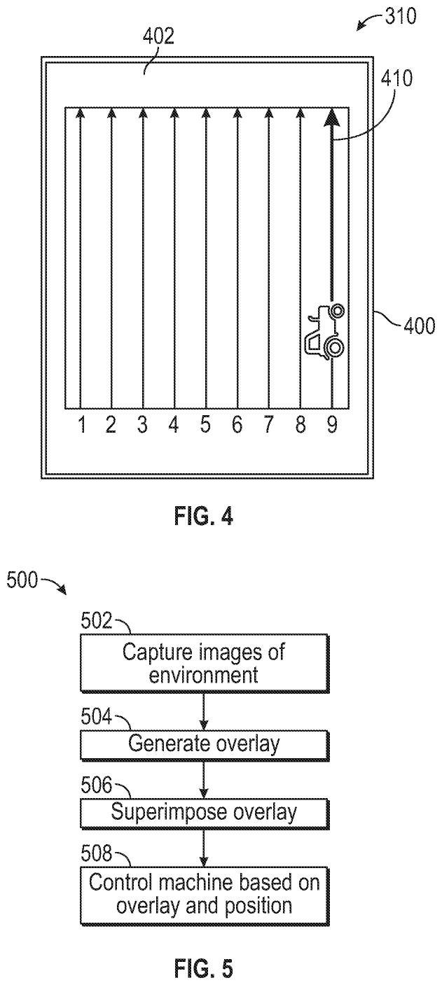

In some example embodiments, the position of the overlay 310 can be placed or aligned at a specific pixel or point on one or more of the image/s 302, 304, 306, 308 based on mounting position of the camera's 162 on the work machine 100, mounting angle, intrinsic information of the camera/s 162 including field of view, GPS position or other location information, etc. This information can be provided by the camera's 162 or by a controller (e.g., controller 160) in communication with the camera's 162. In some examples, the specific point or pixel of the overlay 310 can depend on features of the machine, including articulation points, etc. The overlay 310 is described in more detail with respect to FIG. 4 later herein.

Together, the four images 302, 304, 306, 308 can provide improved spatial awareness to the remote operator, or to a local operator present in the operator's cab 150 while the overlay 310 provides for simultaneous display of information regarding the work area. This allows the operator to view one display showing both the work area and the surroundings around the machine, to prevent or eliminate distractions and other safety concerns and efficiency concerns. While the overlay 310 is shown within the front image 302, the overlay 310 can be depicted in others of the images 304, 306, 308 to provide an accurate depiction of the work area within the surroundings illustrated in images 302, 304, 306, 308. The position of the overlay 310 can be updated periodically, constantly, or upon operator request such that the overlay 310 is kept up to date with motion of the work machine 100, progress in performance of the work plan, or other events, motion, and locations.

An operator (whether remote from work machine 100 or within operator's cab 150) can view depiction 312 of the work machine 100 to determine an orientation at which to steer or place the work machine 100. In the example shown in FIG. 3A, an operator is approaching a work area in front of the work machine 100. The operator can control the work machine 100 to place the work machine 100 in the position shown according to depiction 312. The operator can view the depiction 312 in relation to surroundings depicted in image 302 in the illustrated example. In some examples, the work machine 100 may not be oriented similarly to the depiction 312, in which case the operator may steer or move the work machine 100 so that the work machine 100 is oriented or located similarly to the depiction 312.

In another example shown in FIG. 3B, the overlay 310 is provided in a view 308 behind the work machine. In the example shown in FIG. 3B, an operator is approaching a work area behind of the work machine 100. The operator can control the work machine 100 to place the work machine 100 in the position shown according to depiction 314. The operator can view the desired position in relation to surroundings depicted in image 308 in the illustrated example. In other examples, the work area may be to the left or the right of the work machine 100, in which case the overlay 310 may appear in image 304 or 306, respectively.

Referring to both of FIG. 3A and FIG. 3B, in some examples, the work machine 100 may be located at some distance from a location depicted by depiction 312, 314. In at least these embodiments, the operator may steer the work machine 100 or the work machine 100 may be directed in an autonomous fashion to the location corresponding to depiction 312, 314. In some examples, the depiction 312, 314 can include information regarding a starting location for the work machine 100 for implementing the work plan. In at least these examples, the work machine 100 may not be located near the starting location and the work machine 100 can receive autonomous or remote-controlled instructions to proceed to the starting location.

FIG. 4 illustrates detail of the overlay 310 in accordance with some embodiments. The overlay 310 can be generated by, for example, processing circuitry 230 within the remote control apparatus 101 (FIG. 1 or 2B) or the processing circuitry 231 within the remote operator station 200 (FIG. 2B). The overlay 310 depicts a work plan that can be implemented by a work machine 100, The example work plan can be especially pertinent to a compactor machine's work plan (e.g., a compaction plan), although embodiments are not limited to compactor machine work areas. For example, work areas can be depicted related to motor grader work plans, mixer work plans, paver work plans, and other machine work plans. In some examples, the overlay 310 can include a cut-and-fill map for a cut-and-fill operation to be performed by the work machine 100. In a cut-and-fill map according to embodiments, a “cut” represents an area where the existing elevation exceeds the desired elevation and, conversely, a “fill” area is an area where the existing topography lies below the desired elevation line A work machine 100 therefore should remove material from a cut area of a cut-and-fill map, and add material (whether the same material removed in the cut operation or other material) in a fill area of the cut-and fill map. The cut-and-fill map can be generated based on topography maps provided by, e.g., drones. The overlay 310 can include other job aides (not shown in FIG. 4) including pitch and roll information, slope and side slope information, guidance lines for the work machine 100, depictions of tire lines of the work machine 100, or other information related to work machines and work plans of any type, including motor graders and other work machines. The overlay 310 can include a machine depiction 400 indicating a continuously or periodically updated current position of the work machine 100 within a work area 402. The machine depiction 400 can be oriented to indicate present direction of movement of the work machine 100 in the work area 402.

The work plan illustrated can be uploaded or retrieved from a database of autonomous tasks saved locally or remotely from the work machine 100 or remote control location. The operator of work machine 100 can also select a particular task, review and change parameters/characteristics of the task, command work machine 100 to initiate a task, as well as command work machine 100 to cease a task, as examples. The controller 160 can know the work area 402 from a work site plan input and can know the width of the compactor roller and then divides the work area 402 into the required number of work lanes 410.

When a site plan calls for a certain number of passes by a work machine (e.g., compactor machine), a pass pattern for the work machine 100 (FIG. 1) can be developed in view of the number of a plurality of work lanes 410 and the number of passes required. For example, in the example work area 402, there are nine work lanes marked 1-9. For example, a compactor may have to go up and back (one pass), then move over and repeat until the end lane is finished. If multiple passes are needed, the compactor machine can then retrace its path to the beginning point. In other words, without any obstructions, the pattern would be to do work lanes 1, 2, 3 and so on up to lane 9 and then lanes 9, 8, 7, 6 and so on back to lane 1.

In the example shown in FIG. 4, each of the plurality of work lanes 410 is approximately equal in width and in total cover the entire work area 402. The depiction of work lanes can include indicators (e.g., arrows) 410 indicating present and subsequent directions that the compactor machine should travel to complete a work plan.

FIG. 5 is a flowchart depicting an example method 500 of operating a work machine 100 in accordance with this disclosure. The method 500 can be performed by elements of FIG. 1, FIG. 2A and FIG. 2B, including in particular cameras 162, remote control apparatus 101, remote operator station 200, processing circuitry 230, processing circuitry 231, controller 160, etc.

The method 500 can begin with operation 502 with the cameras 162 capturing an image of at least a portion of an environment adjacent to the work machine 100. The method 500 can continue with operation 504 with the processing circuitry 230 generating an overlay 310 that depicts a work area for the work machine 100.

The method 500 can continue with operation 506 with the processing circuitry 230 or the processing circuitry 231 superimposing the overlay 310 over the image to generate an enhanced image 300 of the work area. The method 500 can continue with the controller 160 controlling the working machine to perform work in the work area based on the overlay and a position of the working machine within the work area.

The method 500 can comprise any of the other operations of processing circuitry 230 or processing circuitry 231 described above, or of the displays described above with reference to FIG. 3A and FIG. 3B. For example, the method 500 can include generating a composite view of the environment adjacent to the work machine using the images and to superimpose the overlay over the composite view. The composite view can be similar to that describe above with respect to FIGS. 3A and 3B. For example, the composite view can include images captured by a plurality of cameras 162 of the front, sides, rear, etc. relative to a operator's cab 150.

The method 500 can include determining size, location, dimensions, etc. of a work area within which the work machine 100 will perform predefined or ad hoc autonomous or manual operations. The size, location, dimensions, etc. can be determined by accessing stored location information of the work area, location sensors of the work machine 100, and any other available sensors or systems, including satellite systems.

### INDUSTRIAL APPLICABILITY

In general, work machine 100 can be configured and equipped to operate without in-situ operator control, whether such operation includes remote manual control of the machine or remote autonomous task control. For example, an operator can employ remote control apparatus 101 or the remote operator station 200 to manually propel (and direct/steer) work machine 100 into a starting position for a preplanned autonomous task to be completed by the work machine. After properly positioning work machine 100, the operator employs remote operator station 200 or remote control apparatus 101 to cause the work machine to initiate the autonomous task.

While the work machine 100 is executing the autonomous task, the operator uses remote control apparatus 101 or remote operator station 200 to monitor progress of the task by the machine. Remote control can be provided with improved safety features by including a display in accordance with systems and methods according to this disclosure. An image of a work area, including depictions related to a work plan of the work machine, are provided as an overlay over image data provided by cameras and/or other imaging equipment of the work machine as shown in FIG. 3A and FIG. 3B. This overlay system allows users to perform work while still keeping track of areas surrounding the work machine, without loss of focus on either the work being performed or the surroundings. Operators can also use the image data in conjunction with the overlay to guide a work machine to a predetermined location before work is performed.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
an image capturing device configured to capture an image of at least a portion of an environment adjacent to the work machine; and
processing circuitry configured to:
receive the image from the image capturing device;
generate an overlay that depicts a work area for the work machine;
superimpose the overlay over the image to generate an enhanced image of an area to be worked in the work area; and
provide the enhanced image to a display device.

2. The work machine of claim 1, further comprising a plurality of image capturing devices, and wherein the plurality of image capturing devices is configured to capture images of different portions of the environment adjacent to the work machine.

3. The work machine of claim 2, wherein the processing circuitry is configured to generate a composite view of the environment adjacent to the work machine using the images and to superimpose the overlay over the composite view.

4. The work machine of claim 1, wherein the processing circuitry is configured to determine parameters of the work area by accessing location information for the work area.

5. The work machine of claim 4, further comprising a sensor to detect location information, and wherein the processing circuitry is configured access location information from the sensor.

6. The work machine of claim 5, wherein the location information is accessed from a device located remotely from the work machine.

7. The work machine of claim 1, wherein the overlay includes information or a work plan of the work machine.

8. The work machine of claim 7, wherein the overlay includes a cut-and-fill map for a cut-and-fill operation to be performed by the work machine.

9. The work machine of claim 7, wherein the overlay includes a compaction plan for a compaction operation to be performed by the work machine.

10. The work machine of claim 7, wherein the overlay includes indicators to indicate a travel direction for the work machine.

11. The work machine of claim 7, wherein the overlay includes indicators to indicate subsequent work operations for implementing the work plan.

12. The work machine of claim 7, wherein the overlay includes indicators to indicate a starting location for the work machine for implementing the work plan.

13. The work machine of claim 1, wherein the processing circuitry is configured to update the overlay based on location information of the work machine.

14. The work machine of claim 1, wherein the display device is located remotely from the work machine.

15. The work machine of claim 1, wherein the display device is located at the work machine.

16. A method of remote control for a work machine, the method comprising:
capturing an image of at least a portion of an environment adjacent to the work machine;
generating an overlay that depicts a work area for the work machine;
superimposing the overlay over the image to generate an enhanced image of
an area to be worked in the work area; and
controlling the work machine to perform work in the work area based on the overlay and a position of the work machine within the work area.

17. The method of claim 16, further comprising:
capturing a plurality of images of a plurality of portions of the environment adjacent to the work machine;
generating a composite view of the environment adjacent to the work machine using the plurality of images; and
superimposing the overlay over the composite view.

18. The method of claim 16, further comprising:
determining parameters of the work area by accessing location information for the work area;
accessing location information for the work machine; and
controlling the work machine based on parameters of the work area and the location information.

19. A system comprising:
an image capturing device configured to capture an image of at least a portion of an environment adjacent to a work machine;
a location sensor configured to detect location of the work machine;
processing circuitry configured to:
receive the image from the image capturing device;
generate an overlay that depicts a work area for the work machine; and
superimpose the overlay over the image to generate an enhanced image of an area to be worked in the work area; and
a display connected to the processing circuitry and configured to receive the enhanced image and display the enhanced image.

20. The system of claim 19, further comprising a plurality of image capturing devices, and wherein the plurality of image capturing devices is configured to capture images of different portions of the environment adjacent to the work machine.
